(19) United States
(12) Patent Application Publication
(10) Pub. No.: US 2007/0046272 A1
(43) Pub. Date: Mar. 1, 2007

(54) Non-linear circuit

(76) Inventor: Kazuo Kawai, Tokyo (JP)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/416,777

(22) Filed: May 3, 2006

(30) Foreign Application Priority Data
Aug. 29, 2005 (JP) JP 2005-247957

(51) Int. Cl. G05F 1/00

(52) U.S. Cl. 323/282

(57) ABSTRACT

A non-linear circuit includes a non-linear basic circuit which is provided with an op amplifier, negative feedback circuits thereof, a positive feedback circuit thereof, an input resistor and a second input resistor and transforms an input control voltage into a non-linear basic control voltage; a weighting circuit which includes voltage division resistors and divides the input control voltage; an offset voltage applying circuit which includes an offset voltage source and generates an offset voltage; and an adding circuit which includes a second op amplifier, negative feedback circuits thereof and third, fourth and fifth input resistors thereof and which adds the non-linear basic control voltage, division control voltage and offset voltage together and outputs the result of addition thereof. A controlled load circuit including a non-linear element is connected to the output of the second op amplifier.

### RELATED/PRIORITY APPLICATION

This application claims priority with respect to Japanese Application No. 2005-247957, filed Aug. 29, 2005.

### BACKGROUND OF THE INVENTION

1. Field of the Invention

The present invention relates to a non-linear circuit, and particularly to a non-linear circuit which supplies to a circuit element assuming a non-linear characteristic like a voltage-capacitance characteristic of a variable capacitance diode, a control voltage having a non-linear characteristic complementary to the non-linear characteristic, and corrects the non-linear characteristic of the circuit element to allow its voltage characteristic to be substantially linear.

2. Description of the Related Art

A variable capacitance diode having a nonlinear voltage-capacitance characteristic has heretofore been frequently used as a variable capacitance element which constitutes a tuning circuit or a voltage-controlled oscillator or the like. In such a case, the nonlinear voltage-capacitance characteristic has been positively utilized. The nonlinear voltage-capacitance characteristic of such a variable capacitance diode is obtained by greatly changing its junction capacitance according to the magnitude of a reverse bias voltage when the reverse bias voltage is applied to the PN junction of the diode. Since the state of a change in its junction capacitance is determined according to many variable factors such as permittivity of a depletion layer, a diffusion potential, the magnitude of a reverse bias voltage, a coefficient determined based on an impurity distribution, etc., the junction-capacitance change characteristic of the variable capacitance diode is not uniform over its entirety.

However, the trend in the junction-capacitance change characteristic of the whole variable capacitance diode is that assuming that the reverse bias voltage and the junction capacitance are respectively taken on the horizontal and vertical axes and represented on a logarithmic scale, and changes in capacitance obtained at this time are plotted, the junction capacitance increases in a region in which the reverse bias voltage is low, whereas the junction capacitance decreases in a region in which the reverse bias voltage is high, and besides the slope of a change in capacitance in a region in which the junction capacitance is small, becomes gentle. Therefore, a region in which the junction capacitance is large, i.e., a region in which the slope of the change in capacitance is relatively steep, is normally determined specifically as a region intended for utilization in the variable capacitance diode.

The variable capacitance diode has the junction-capacitance change characteristic which assumes such a non-linear characteristic. However, when, for example, the variable capacitance diode is used in a variable capacitance element of a voltage-controlled oscillator or the like lying in a phase-locked loop, the capacity of the variable capacitance diode can always be converged into the optimum value because the phase-locked loop per se has a pull-in function.

On the other hand, when the variable capacitance diode is used in a circuit in which a frequency adjustment is made manually, and the frequency of the circuit is adjusted manually, e.g., when a filter's cutoff frequency at an active low-pass filter or an active high-pass filter is adjusted manually, when a center frequency of an active bandpass filter or the like is adjusted manually, and when the oscillation frequency of a voltage-controlled oscillator is adjusted manually, their circuits are used in a state excluding the phase-locked loop. Therefore, if the voltage-junction capacitance characteristic of the variable capacitance diode is placed in a state following an exponential function curve upon application of a varying reverse bias voltage to the variable capacitance diode, frequency control sensitivity relative to variations in the reverse bias voltage increases in sequence as the reverse bias voltage varies from a high state to a low state. Therefore, it is realistically much difficult to perform a desired frequency setting by a manual adjustment in a region in which the frequency control sensitivity is large.

### SUMMARY OF THE INVENTION

The present invention has been made in view of such a technological background. An object of the present invention is to provide a non-linear circuit which is capable of supplying a control voltage having a non-linear characteristic complementary to a non-linear characteristic of a non-linear element assuming it to the non-linear element and correcting the non-linear, characteristic so as to assume a substantial linear characteristic.

According to one aspect of the present invention, for attaining the above object, there is provided a non-linear circuit having means which comprises a non-linear basic circuit which transforms an input control voltage into a non-linear basic control voltage, a weighting circuit which transforms the input control voltage into a division control voltage, an offset voltage applying circuit which generates an offset voltage, and an adding circuit which adds the non-linear basic control voltage, the division control voltage and the offset voltage together, and wherein the non-linear basis circuit includes an op amplifier, a negative feedback circuit comprising a resistor and a transistor negative feedback-connected to the op amplifier, a positive feedback circuit comprising a resistor positive feedback-connected to the op amplifier, an input resistor which supplies the control voltage to the op amplifier, and a second input resistor which supplies the control voltage to the transistor, the weighting circuit includes voltage division resistors which divide the control voltage, the offset voltage applying circuit includes an offset voltage source, the adding circuit includes a second op amplifier, a negative feedback circuit comprising resistors negative feedback-connected to the second op amplifier, and third, fourth and fifth input resistors which respectively supply the non-linear basic control voltage, the division control voltage and the offset voltage to a non-inversion input of the second op amplifier, and a controlled load circuit is connected to an output of the second op amplifier.

According to the negative feedback circuit comprising the resistor and transistor negative feedback-connected to the op amplifier in the above means, the resistor is connected between an output of the op amplifier and its inversion input, a collector-emitter path of the transistor is connected between the inversion input of the op amplifier and a ground point, and the second input resistor is connected to a base of the transistor.

According to the positive feedback circuit comprising the resistor positive feedback-connected to the op amplifier in the above means, the resistor is connected between the output of the op amplifier and a non-inversion input thereof, and the input resistor is connected to the non-inversion input of the op amplifier.

As described above, the non-linear circuit according to the present invention includes a non-linear basic circuit which transforms a control voltage into a non-linear basic control voltage, a weighting circuit which transforms the control voltage into a division control voltage, an offset voltage applying circuit which generates an offset voltage, and an adding circuit which adds the non-linear basic control voltage, the division control voltage and the offset voltage together. The non-linear circuit brings about advantageous effects in that if the respective gains of the op amplifier used in the non-linear basic circuit and the second op amplifier used in the adding circuit, the resistance values of the various resistors used in the non-linear basic circuit, weighting circuit and adding circuit, and the offset voltage formed by the offset voltage applying circuit are suitably adjusted in such a manner that a non-linear characteristic complementary to a non-linear characteristic of a non-linear element of the controlled load circuit intended for compensation of the non-linear basic circuit is obtained, then the non-linear characteristic of the non-linear element of the controlled load circuit can substantially be brought to a linear characteristic with respect to the control voltage which varies in a wide voltage range, and when the non-linear element is adjusted manually, a desired adjustment can be achieved without difficulty.

Other features and advantages of the present invention will become apparent upon a reading of the attached specification.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a block diagram showing a plurality of component parts which form a non-linear circuit;

FIG. 2 is a principle block diagram illustrating one example of a configuration of a non-linear basic circuit used in the non-linear circuit shown in FIG. 1;

FIG. 3 is a circuit diagram depicting one specific configurational example of a non-linear basic circuit used in the non-linear circuit shown in FIG. 1;

FIG. 4 is a characteristic diagram constituted of five curves indicative of the states of changes in input/output characteristic of the non-linear basic circuit and is a list showing an example of use of respective resistance values for obtaining the five curves;

FIG. 5 is a circuit diagram showing one example of a specific configuration of the entire non-linear circuit shown in FIG. 1;

FIG. 6 is a characteristic diagram for describing a transformation process at the time that linear-nonlinear transformations respectively different in the non-linear basic circuit are executed;

FIG. 7 is a characteristic diagram showing a plurality of linear-nonlinear transformation examples derived by the transformation process shown in FIG. 6;

FIG. 8 is a characteristic diagram illustrating a relationship of change between an applied voltage and a junction capacitance where a reverse bias voltage is applied to a junction of a variable capacitance diode; and

FIG. 9 is a characteristic curve showing a non-linear characteristic required of a non-linear circuit, i.e., a relationship between an input control voltage and an output correction control voltage of the non-linear circuit.

### DETAILED DESCRIPTION OF THE PREFERRED EMBODIMENTS

Preferred embodiments of the present invention will be explained hereinafter with reference to the accompanying drawings.

A non-linear circuit includes a controlled load circuit provided with a non-linear element, which is connected to the output of the non-linear circuit upon its use. In the non-linear circuit, an input control voltage supplied to the non-linear circuit is non-linearly processed to form a correction control voltage, and the so-obtained correction control voltage is supplied to the non-linear element of the controlled load circuit, whereby a non-linear characteristic indicated by the non-linear element is transformed into a linear characteristic apparently. Since a variable capacitance diode is known as a typical non-linear element which needs such nonlinear characteristic-to-linear characteristic transformation, the present embodiment will be explained with the non-linear element of the controlled load circuit as the variable capacitance diode.

Upon execution of the nonlinear characteristic-to-linear characteristic transformation of the variable capacitance diode connected to the controlled load circuit, the non-linear characteristic realized by the non-linear circuit is used to form such a correction control voltage that the relationship between the input control voltage supplied to the non-linear circuit and the junction capacitance of the variable capacitance diode changes approximately linearly. In the present non-linear circuit, the required non-linear characteristic is obtained through the following control adjustment procedure.

On the other hand, as the variable capacitance diode connected to the controlled load circuit, various ones have been manufactured and sold from many manufacturers according to the range of a change in its junction capacitance, its change characteristic, etc. In the present embodiment, however, the following description will be made by citing, as an example, a case in which a JDV3C11 variable capacitance diode manufactured by the T company relatively wide in the change range of the junction capacitance is used as the variable capacitance diode connected to the controlled load circuit.

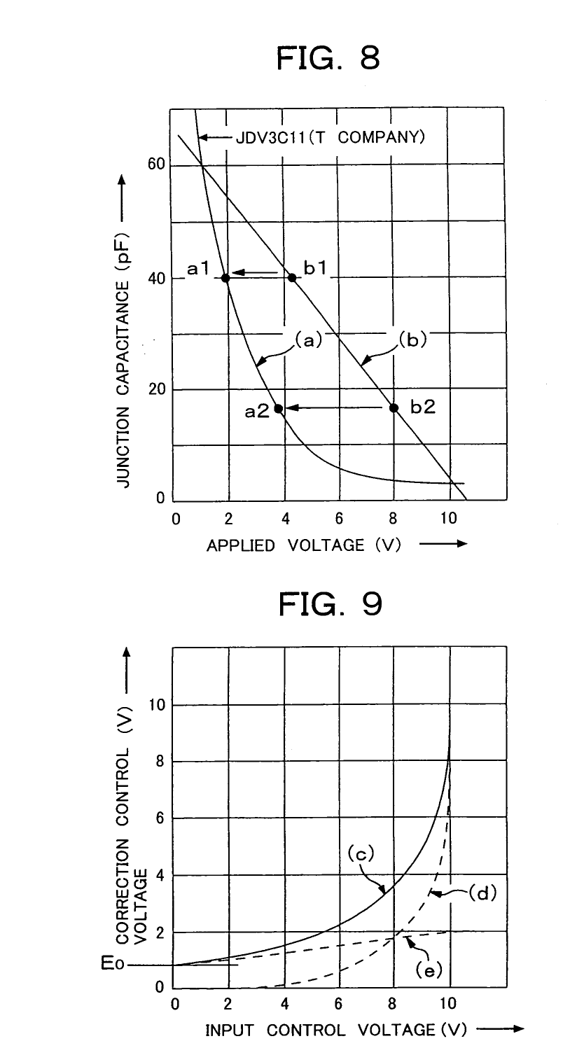

FIG. 8 is a characteristic diagram showing a relationship of change between an applied voltage and a junction capacitance at the time that a reverse bias voltage is applied to the junction of the variable capacitance diode (JDV3C11 manufactured by T company).

In FIG. 8, the horizontal axis indicates an applied voltage (reverse bias voltage) expressed in volt (V), and the vertical axis indicates a junction capacitance expressed in picofarad (pF). Both of the horizontal axis and the vertical axis are respectively represented on a linear scale.

A curve a shown in FIG. 8 indicates an applied voltage-junction capacitance characteristic curve indicated by the variable capacitance diode when a control voltage (reverse bias voltage) is directly supplied to the variable capacitance diode and the so-supplied control voltage is changed. A curve b shown in FIG. 8 indicates an applied voltage-junction capacitance characteristic curve indicated by the variable capacitance diode when a correction control voltage outputted from the non-linear circuit according to the present embodiment is supplied to the variable capacitance diode and the so-supplied correction control voltage is changed.

As is apparent from the two characteristic curves a and b shown in FIG. 8, the present non-linear circuit has such a non-linear characteristic that when the input control voltage is changed as shown in the curve b, the correction control voltage outputted from the non-linear circuit changes as shown in the curve a. The characteristic indicated by the curve b is transformed into, for example, such a characteristic that when the value of the input control voltage is given as a point b1 on the curve b, the value of the correction control voltage becomes a point a1 on the curve a and when the value of the input control voltage is given as a point b2 on the curve b, the value of the correction control voltage becomes a point a2 on the curve a.

Next, FIG. 9 is a characteristic curve showing a non-linear characteristic required of the non-linear circuit, i.e., a relationship between an input control voltage and an output correction control voltage of the non-linear circuit.

In FIG. 9, the horizontal axis indicates an input control voltage expressed in volt (V), and the vertical axis indicates a correction control voltage expressed in volt (V). Both of the horizontal axis and the vertical axis are respectively represented on a linear scale.

A curve c shown in FIG. 9 indicates a non-linear characteristic curve required of the non-linear circuit, and curves d and e respectively indicate two additive curves formed to obtain the curve c. An offset voltage E0 indicates an offset voltage added to obtain the curve c.

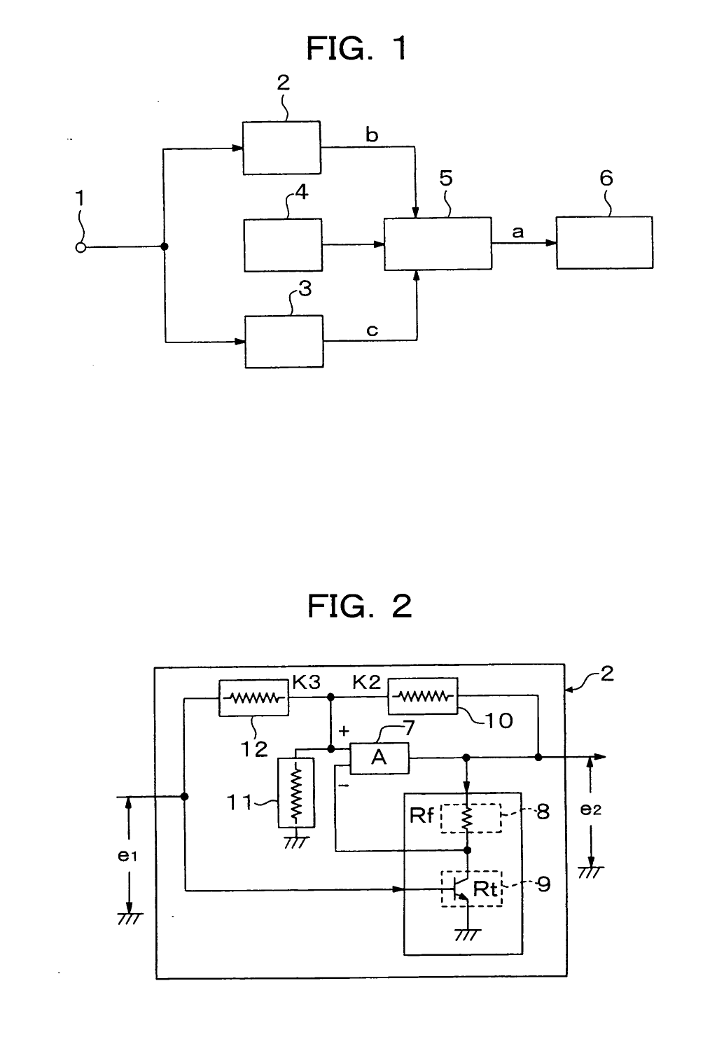

FIG. 1 is a block diagram showing a plurality of component parts that form the non-linear circuit, i.e., the component parts that form the two curves d and e shown in FIG. 9, the component part that forms the offset voltage E0 and the component part that obtains the curve c shown in FIG. 9 by integrating them.

As shown in FIG. 1, the non-linear circuit comprises a control voltage input terminal 1, a non-linear basic circuit 2, a weighting circuit 3, an offset voltage applying circuit 4, an adding circuit 5 and a controlled load circuit 6.

And the input of the non-linear basic circuit 2 and the input of the weighting circuit 3 are respectively connected to the control voltage input terminal 1. The output of the non-linear basic circuit 2, the output of the weighting circuit 3 and the output of the offset voltage applying circuit 4 are connected to their corresponding three addition inputs of the adding circuit 5. The output of the adding circuit 5 is connected to the input of the controlled load circuit 6.

When a control voltage Vc is inputted to the control voltage input terminal 1, the control voltage Vc is divided into two, one of which is inputted to the non-linear basic circuit 2 and the other of which is inputted to the weighting circuit 3. The non-linear basic circuit 2 is used to form the curve d shown in FIG. 9. The non-linear basic circuit 2 performs a linear-to-nonlinear transformation such that the input control voltage Vc becomes a non-linear characteristic extending along the curve d and supplies the so-transformed first transformation control voltage to the adding circuit 3. The weighting circuit 3 is used to form the curve e shown in FIG. 9. The weighting circuit 3 performs such a transformation that the input control voltage Vc becomes a linear characteristic extending along the curve e and supplies the so-transformed second transformation control voltage to the adding circuit 3. Further, the offset voltage applying circuit 4 is used to form an offset component in the curve c and supplies an offset voltage E0 obtained by an offset voltage source to the adding circuit 3.

The adding circuit 5 adds the first transformation control voltage, the second transformation control voltage and the offset voltage supplied thereto together. From the result of addition thereof, a correction control voltage along the curve c is formed at the output of the adding circuit 5. The correction control voltage is supplied to a variable capacitance diode (not shown in FIG. 1) of the controlled load circuit 6 and used for the transformation of a non-linear characteristic into a linear characteristic at the variable capacitance diode as mentioned above.

Next, FIG. 2 is a principle block diagram illustrating one example of a configuration of the non-linear basic circuit 2 used in the non-linear circuit shown in FIG. 1.

As shown in FIG. 2, the non-linear basic circuit 2 comprises an op amplifier 7, a negative feedback resistor 8 and a common-emitter transistor 9 that constitute a negative feedback circuit, a positive feedback resistor 10 that constitutes a positive feedback circuit, an adding resistor 11 and an input resistor 12. Assuming that a weighting factor indicated by the positive feedback circuit is k2, a weighting factor indicated by the input resistor 12 is k3, the gain of the op amplifier 7 is A, the resistance value of the negative feedback resistor 8 is Rf, the high-frequency or RF resistance value between the collector and emitter of the transistor 9 is Rt, an input control voltage is e1, and an output first transformation control voltage is e2 in the non-linear basic circuit 2 based on such a configuration as described above, an input/output characteristic e2/e1 of the non-linear basic circuit 2 is given by the following equation (1):
e2/e1=k3/{(1/A)+Rt/(Rf+Rt)−k2} (1)

In the equation (1), the term of Rt/(Rf+Rt) including the resistance value Rf of the negative feedback resistor 8 and the high-frequency resistance value Rt of the transistor 9 represents a negative feedback factor β of the negative feedback circuit of the op amplifier 7. When the input control voltage e1 increases or decreases, the direction of an increase or decrease in the input control voltage e1 and the direction of an increase or decrease in the high-frequency resistance value Rt are made opposite to each other. Thus, the direction of the increase or decrease in the input control voltage e1 and the direction of an increase or decrease in the negative feedback factor β are also reversed each other.

If the high-frequency resistance value Rt of the transistor 9 changes within a range of 0.01 to 100 when the resistance value Rf of the negative feedback resistor 8 is now assumed to be 1, for example, then the negative feedback factor β, i.e., Rt/(Rf+Rt) changes within a range from about 0.01 to 0.99. When the following condition is not met in this case, the operation of the non-linear circuit becomes instable and hence the weighting factor k2 related to the positive feedback circuit is substantially unavailable.
K2<(1/A)+β (2)

It is therefore necessary to meet this expression. Incidentally, while the weighting factor k2 cannot be determined uniquely unless the gain A and negative feedback factor β of the op amplifier 7 are determined, the influence of a change in the high-frequency resistance value Rt of the transistor 9 often appears with respect to the input/output characteristic e2/e1 as the gain A of the op amplifier 7 decreases, the resistance value Rf of the negative feedback resistor 8 increases and k2 becomes large within the range in which k2 meets the expression (2).

From these, the non-linear basic circuit 2 suitably changes a bending characteristic of the high-frequency resistance value Rt of the transistor 9, which changes nonlinearly in response to a change in the input control voltage e1, the resistance value Rf of the negative feedback resistor 8 in the negative feedback circuit, the gain A of the op amplifier 7, the weighting factor k2 based on the positive feedback resistor 10 of the positive feedback circuit, etc. to thereby make it possible to increase or decrease the degree of bending at the nonlinear portion of the input/output characteristic e2/e1 and the size of its curvature, and the like. When, however, theses elements are suitably changed, the gain of the non-linear basic circuit 2 might increase or decrease depending upon the states of their changes. It is therefore necessary to simultaneously correct the increase and decrease in the gain of the non-linear basic circuit 2.

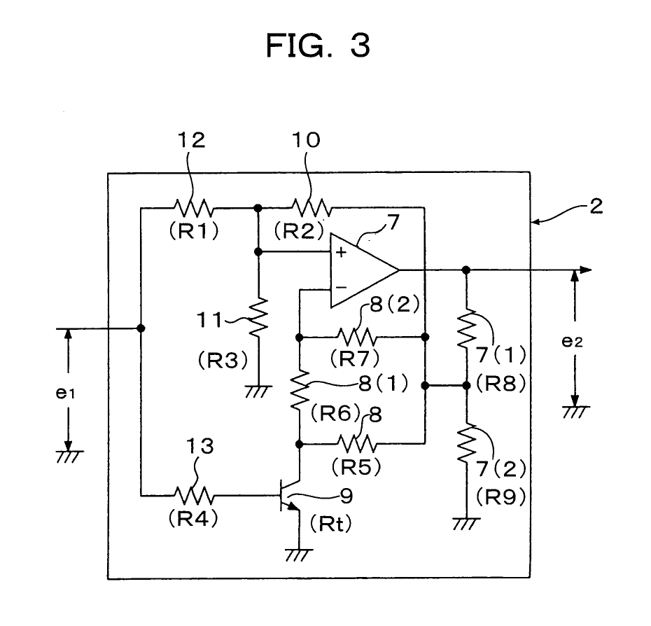

Next, FIG. 3 is a circuit diagram showing one specific configurational example of the non-linear basic circuit 2 used in the non-linear circuit illustrated in FIG. 1.

In FIG. 3, reference numerals 7(1) and 7(2) indicate voltage-division resistors, reference numeral 8(1) indicates a second negative feedback resistor, reference numeral 8(2) indicates a third negative feedback resistor, and reference numeral 13 indicates a second input resistor, respectively. In addition, the same constituent elements as those shown in FIG. 2 are given the same reference numerals, and their description will therefore be omitted.

Comparing the non-linear basic circuit 2 (hereinafter called “present example circuit 2” for convenience) of the present configurational example illustrated in FIG. 3 and the non-linear basic circuit 2 (hereinafter called “previous example circuit 2” for convenience) of the previous configurational example shown in FIG. 2, the present example circuit 2 and the previous example circuit 2 are slightly different in configuration from each other in that in the present example circuit 2, the output voltage of an op amplifier 7 is divided by the voltage-division resistors 7(1) and 7(2) and its divided voltage is supplied to a negative feedback resistor 8 and a positive feedback resistor 10, whereas in the previous example circuit 2, the output voltage of the op amplifier 7 is directly supplied to the negative feedback resistor 8 and the positive feedback resistor 10, and the present example circuit 2 uses the second negative feedback resistor 8(1) and the third negative feedback resistor 8(2) together in addition to the negative feedback resistor 8, whereas the previous example circuit 2 makes use of the negative feedback resistor 8 alone. However, the present example circuit 2 and the previous example circuit 2 are respectively provided with the same circuit configuration basically, and their operations are also almost the same in essence.

Assuming that in the present example circuit 2, the resistance value of an input resistor 12 is R1, the resistance value of the positive feedback resistor 10 is R2, the resistance value of an adding resistor 11 is R3, the resistance value of a second input resistor 13 is R4, the resistance value of the negative feedback resistor 8 is R5, the resistance value of the second negative feedback resistor 8(1) is R6, the resistance value of the third negative feedback resistor 8(2) is R7, the resistance value of the voltage-division resistor 7(1) is R8, and the resistance value of the voltage-division resistor 7(2) is R9, and their resistance values R1 through R9 are respectively changed within predetermined ranges, the state of a non-linear portion of an input/output characteristic e2/e1 can be changed corresponding to changes in the resistance values R1 through R9.

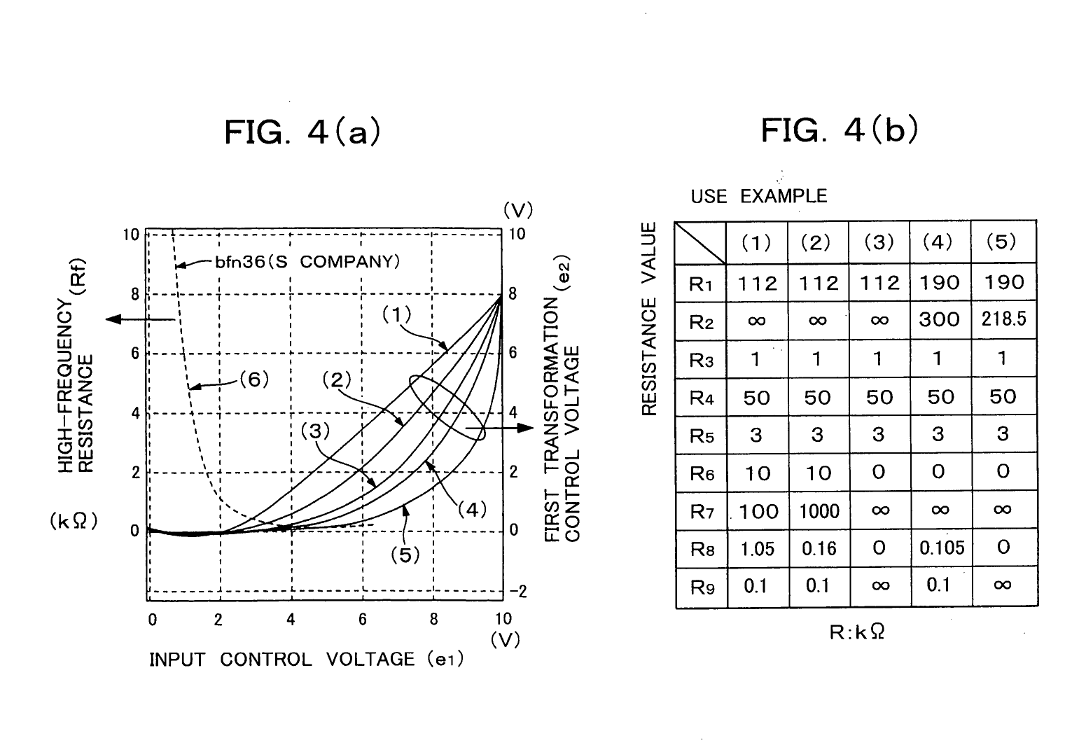

Now, FIG. 4(a) is a characteristic diagram comprising five curves each indicative of the state of a change in the input/output characteristic (e2/e1) of the present example circuit 2, and FIG. 4(b) is a list showing examples of use of the respective resistance values R1 through R9 for obtaining the five curves.

In FIG. 4(a), the horizontal axis indicates an input control voltage e1 expressed in volt (V). One vertical axis (right side) indicates an output first transformation control voltage e2 expressed in volt (V), and the other vertical axis (left side) indicates a high-frequency resistance Rt of the transistor 9, which is expressed in kiloohm (kΩ). The five curves of (1) through (5) respectively indicate different states of changes in the input/output characteristic e2/e1. A curve designated at (6) indicates a state of a change in the high-frequency resistance Rt of the transistor 9 with respect to the input control voltage e1.

In FIG. 4(b), the horizontal direction indicates five use examples of (1) through (5), and the vertical direction indicates the resistance values R1 through R9 employed in the five use examples of (1) through (5). The five use examples of (1) through (5) respectively correspond to the five curves of (1) through (5).

If finite values (300 kΩ and 218.5 kΩ) are selected as the resistance value R2 of the positive feedback resistor 10 as shown in the use examples (4) and (5) in FIG. 4(b), and thereby the substantial gain of the op amplifier 7 increases, then the degree of curvature of the non-linear portion of the input/output characteristic e2/e1 can be made relatively large as shown in the curves (4) and (5) of FIG. 4(a). If the finite value of the resistance value R2 is set smaller than each value referred to above, then the degree of curvature of the non-linear portion can be made larger. Since, however, the positive feedback circuit of the op amplifier 7 becomes instable in operation where the condition of K 2<(1/A)+β is not met as represented by the expression (2), there is a limit to a reduction in the finite value of the resistance value R2 per se. On the other hand, if the degree of curvature of the non-linear portion may be relatively small as shown in the curves (1), (2) and (3) of FIG. 4(a), then the positive feedback resistor 10 may be brought into an open state without its connection as shown in the use examples (1), (2) and (3) of FIG. 4(b).

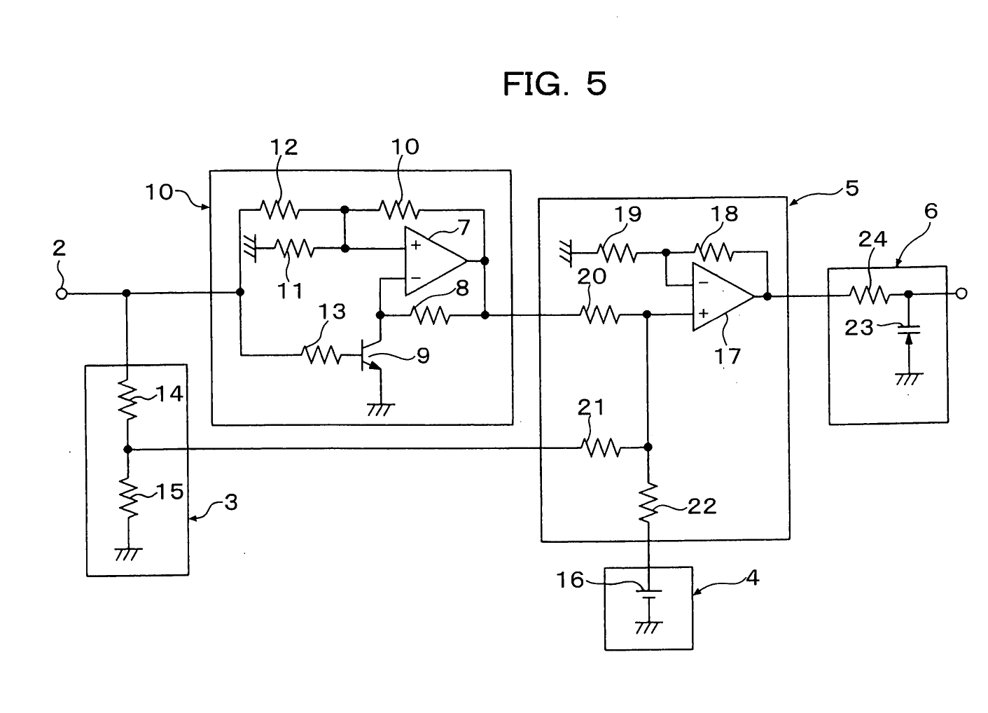

Then, FIG. 5 is a circuit diagram showing one example of a specific configuration of the entire non-linear circuit shown in FIG. 1.

As shown in FIG. 5, the present non-linear circuit is identical in configuration to the non-linear circuit shown in FIG. 1 and includes a control voltage input terminal 1, a non-linear basic circuit 2, a weighting circuit 3, an offset voltage applying circuit 4 and an adding circuit 5. A controlled load circuit 6 is connected to the output side of the adding circuit 5.

In this case, the non-linear basic circuit 2 comprises an op amplifier 7, a negative feedback resistor 8 and a common emitter transistor 9 that constitute a negative feedback circuit, a positive feedback resistor 10 that constitutes a positive feedback circuit, an adding resistor 11, an input resistor 12 and a second input resistor 13,. The weighting circuit 3 comprises a first voltage division resistor 14 and a second voltage division resistor 15 that constitute a voltage division circuit. The offset voltage applying circuit 4 has an offset voltage source 16. The adding circuit 5 comprises a second op amplifier 17, a first negative feedback resistor 18 and a second negative feedback resistor 19 that constitute a negative feedback circuit, a third input resistor 20, a fourth input resistor 21 and a fifth input resistor 22. The controlled load circuit 6 comprises a variable capacitance diode 23 and an input resistor 24.

In the non-linear basic circuit 2, the negative feedback resistor 8 is connected between the output of the op amplifier 7 and its inversion input (−). The common emitter transistor 9 has a collector connected to the inversion input (−) of the op amplifier 7, an emitter connected to a ground point and a base connected to the control voltage input terminal 1 through the second input resistor 13. The positive feedback resistor 10 is connected between the output of the op amplifier 7 and its non-inversion input (+). The adding resistor 11 is connected between the non-inversion input (+) of the op amplifier 7 and the ground point. The input resistor 12 is connected between the non-inversion input (+) of the op amplifier 7 and the control voltage input terminal 1. The op amplifier 7 is connected to one end of the third input resistor 20.

In the weighting circuit 3, the first voltage division resistor 14 and the second voltage division resistor 15 are connected in series between the control voltage input terminal 1 and the ground point. A connecting point of the first voltage division resistor 14 and the second voltage division resistor 15 is connected to one end of the fourth input resistor 21. In the offset voltage applying circuit 4, the offset voltage source 16 has a positive polarity connected to one end of the fifth input resistor 22 and a negative polarity connected to the ground point. Further, in the adding circuit 5, the first negative feedback resistor 18 is connected between the output of the second op amplifier 17 and its inversion input (−), and the second negative feedback resistor 19 is connected between the inversion input (−) of the op amplifier 17 and the ground point. The third input resistor 20, the fourth input resistor 21 and the fifth input resistor 22 have the other ends respectively connected to an inversion input (+) of the second op amplifier 17. The second op amplifier 17 has the output connected to one end of the input resistor 24. In the controlled load circuit 6, the variable capacitance diode 23 has a cathode connected to the other end of the input resistor 24 and its output terminal, and an anode connected to the ground point.

The configuration of the non-linear circuit according to the present example is one in which the configuration shown in the block diagram of the non-linear circuit illustrated in FIG. 1 is represented in the form of a specific circuit. Their configurations are basically identical to each other, and the operations based on their configurations are also identical in essence as already mentioned above. In order to make more evident the operation of the non-linear circuit according to the present example, portions which become its operational essential points, will now be explained in an emphasized manner.

When a control voltage Vc is now inputted to the control voltage input terminal 1, the control voltage Vc is supplied to the non-linear basic circuit 2 and supplied even to the weighting circuit 3. At this time, the non-linear basic circuit 2 performs such a linear-to-nonlinear transformation that the supplied control voltage Vc becomes the non-linear characteristic extending along the curve d illustrated in FIG. 9 by selecting the gain of the op amplifier 7, the resistance value of the negative feedback resistor 8, the resistance value of the positive feedback resistor 10, the resistance value of the adding resistor 11, the resistance value of the input resistor 12 and the resistance value of the second input resistor 13 respectively and forms a first transformation control voltage at its output. The weighting circuit 3 performs such a transformation that the supplied control voltage Vc becomes the linear characteristic extending along the curve e illustrated in FIG. 9 by selecting the resistance value of the first voltage division resistor 14 and the resistance value of the second voltage division resistor 15 respectively and forms a second transformation control voltage at its output. The offset voltage applying circuit 4 selects an output voltage of the offset voltage source and forms an offset voltage ED shown in the curve c illustrated in FIG. 9.

Next, when the adding circuit 5 adds the supplied first transformation control voltage, second transformation control voltage and offset voltage together by selecting the gain of the second op amplifier 17, the resistance value of the first negative feedback resistor 18, the resistance value of the second negative feedback resistor 19, the resistance value of the third input resistor 20, the resistance value of the fourth input resistor 21 and the resistance value of the fifth input resistor 22 respectively, the adding circuit 5 forms, at its output, such a correction control voltage that the result of addition thereof becomes the non-linear characteristic extending along the curve c illustrated in FIG. 9. The correction control voltage obtained at this time is supplied to the variable capacitance diode 23 of the controlled load circuit 6, where a control voltage-junction capacitance nonlinear characteristic exhibited by the variable capacitance diode 23 is transformed into a substantially linear characteristic apparently. It is therefore possible to easily obtain a desired junction capacitance at the variable capacitance diode 23 without spending a lot of efforts on an adjustment to the control voltage Vc where it is desired to obtain the desired junction capacitance by a manual adjustment to the control voltage Vc.

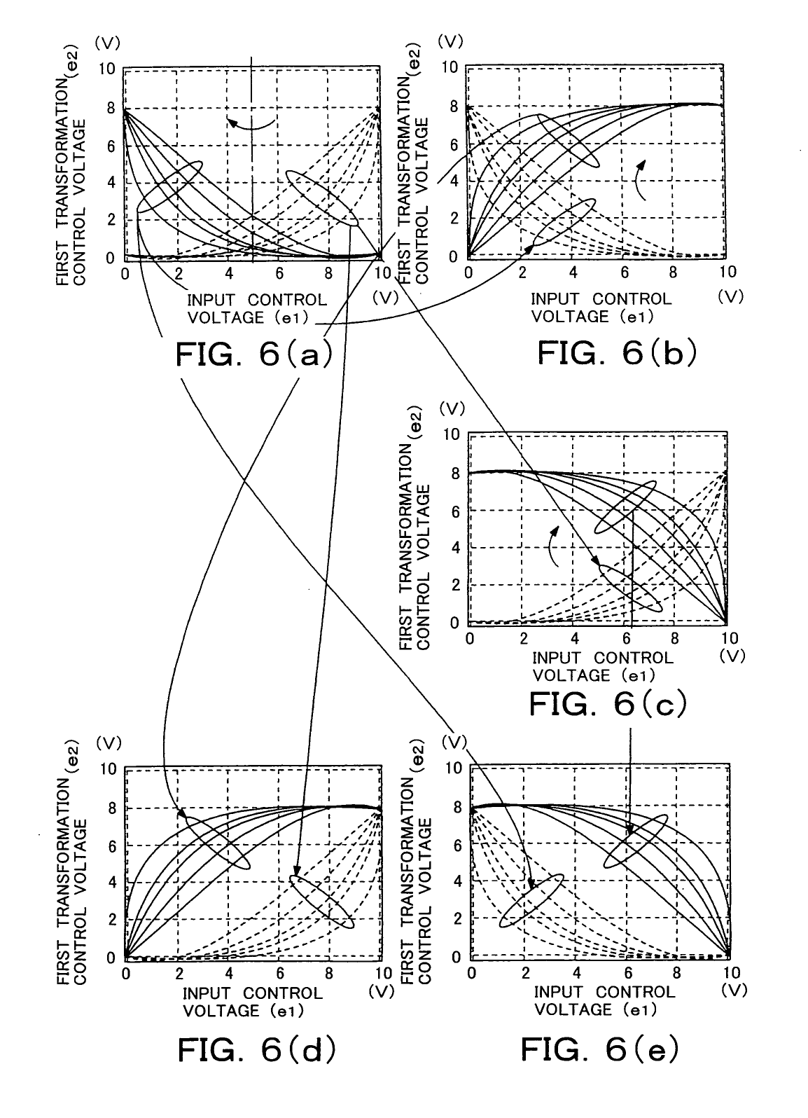

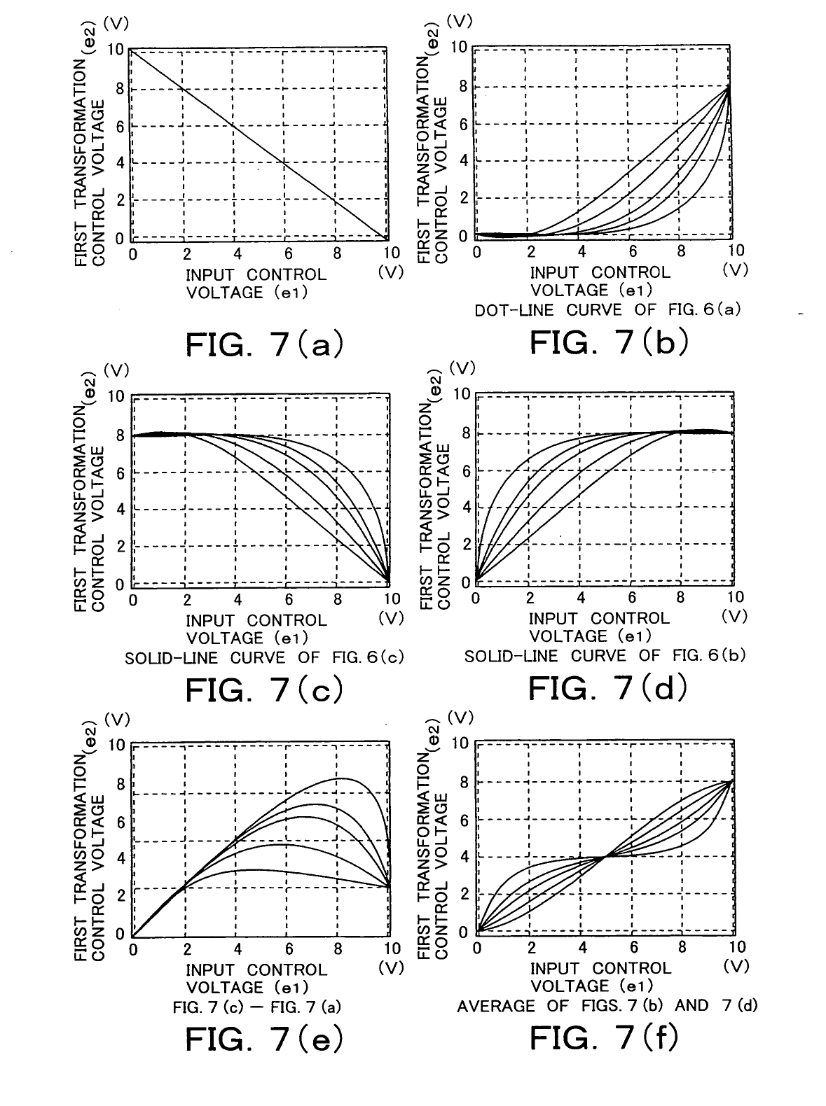

Another embodiment according to a non-linear circuit of the present invention will subsequently be explained using FIGS. 6 and 7.

FIGS. 6(a) through 6(e) are respectively characteristic diagrams for describing a transformation process at the time that linear-to-nonlinear transformations respectively different from one another are executed at the non-linear basic-circuit 2. FIGS. 7(a) through 7(e) are respectively characteristic diagrams showing a plurality of linear-to-nonlinear transformation examples derived by the transformation process shown in FIG. 6.

In FIGS. 6(a) through 6(e) and FIGS. 7(a) through 7(e), the horizontal-axis directions indicate input control voltages (e1) expressed in volt (V), and the vertical-axis directions indicate first transformation control voltages (e2) expressed in volt (V). Incidentally, arcuate arrows shown in FIGS. 6(a) through 6(c) indicate states in which voltage inversions in the array directions have been carried out. A line that passes through the center of each arrow indicates a voltage state at the execution of the voltage inversion.

FIG. 6(a) shows an example in which an input control voltage (e1) of 5V is inverted as an axis line and a group of five solid-line curves and a group of five dot-line curves are respectively formed on the right and left sides of the axis line. The group of five dot-line curves in the example is the same curve group as the group of five curves shown in FIG. 4(b). FIG. 6(b) illustrates an example in which a first transformation control voltage (e2) of 4V is inverted as an axis line and a group of five solid-line curves and a group of five dot-line curves are respectively formed above and below the axis line. The group of five dot-line curves in the example is the same curve group as the group of five solid-line curves shown in FIG. 6(a). FIG. 6(c) depicts an example in which a first transformation control voltage (e2) of 4V is inverted as an axis line and a group of five solid-line curves and a group of five dot-line curves are respectively formed above and below the axis line. The group of five dot-line curves is the same curve group as the group of five dot-line curves shown in FIG. 6(a).

FIG. 6(d) shows an example in which a group of five solid-line curves and a group of five dot-line curves are respectively formed in states of being linearly symmetrical with respect to a straight line that connects respective minimum points (e1=0V and e2=0V) of the input control voltage (e1) and the first transformation control voltage (e2), and respective maximum points (e1=8V and e2=10V) of the input control voltage (e1) and the first transformation control voltage (e2). The group of five dot-line curves in the example is the same curve group as the group of five dot-line curves shown in FIG. 6(a). The group of five solid-line curves in the example is the same curve group as the group of five solid-line curves shown in FIG. 6(b). Similarly, FIG. 6(e) shows an example in which a group of five solid-line curves and a group of five dot-line curves are respectively formed in states of being linearly symmetrical with respect to a straight line that connects a minimum point of the input control voltage (e1) and a maximum point (e1=0V and e2=8V) of the first transformation control voltage (e2), and a maximum point of the input control voltage (e1) and a minimum point (e1=10V and e2=0V) of the first transformation control voltage (e2). The group of five dot-line curves in the example is the same curve group as the group of five solid-line curves shown in FIG. 6(a), and the group of five solid-line curves in the example is the same curve group as the group of-five solid-line curves shown in FIG. 6(c).

Next, FIG. 7(a) shows a change in linear state obtained when a change in linear state of an input control voltage (e1) is inverted with an input control voltage (e1) of 5V as an axis line. FIG. 7(b) shows a group of five solid-line curves identical to the group of five dot-line curves shown in FIG. 6(a). FIG. 7(c) shows a group of five solid-line curves identical to the group of five solid-line curves shown in FIG. 6(c).

Subsequently, FIG. 7(d) shows a group of five solid-line curves identical to the group of five solid-line curves shown in FIG. 6(c). FIG. 7(e) shows a group of five solid-line curves obtained by subtracting the change in linear state illustrated in FIG. 7(a) from the group of five solid-line curves shown in FIG. 7(c). FIG. 7(f) shows a group of five solid-line curves obtained by determining the average value of corresponding curve-group intervals between the group of five solid-line curves shown in FIG. 7(b) and the group of five solid-line curves shown in FIG. 7(d).

Thus, the input/output characteristic (e2/e1) at the non-linear basic circuit 2 can be brought to characteristic curves having various inclined directions and various degrees of curvature by inverting or non-inverting an input control voltage (e1) at a center voltage of its variation width, inverting or non-inverting a first transformation control voltage (e2) at a center voltage of its variation width, or inverting or non-inverting an input control voltage (e1) and a first transformation control voltage (e2) at center voltages of their variation widths.

If non-linear characteristics having characteristic curves having various inclined directions and various degrees of curvature are obtained at the non-linear basic circuit 2, then characteristic curves each having a non-linear characteristic complementary to the non-linear characteristic of the non-linear element used in the controlled load circuit 6 can be arbitrarily formed according to the non-linear characteristic of the non-linear element. Hence a non-linear circuit is obtained which can be used for compensation of non-linear characteristics of various non-linear elements.

While the preferred forms of the present invention have been described, it is to be understood that modifications will be apparent to those skilled in the art without departing from the spirit of the invention. The scope of the invention is to be determined solely by the following claims.

What is claimed is:

1. A non-linear circuit comprising:
a non-linear basic circuit which transforms an input control voltage into a non-linear basic control voltage;
a weighting circuit which transforms the input control voltage into a division control voltage;
an offset voltage applying circuit which generates an offset voltage; and
an adding circuit which adds the non-linear basic control voltage, the division control voltage and the offset voltage together,
wherein the non-linear basis circuit includes an op amplifier, a negative feedback circuit comprising a resistor and a transistor negative feedback-connected to the op amplifier, a positive feedback circuit comprising a resistor positive feedback-connected to the op amplifier, an input resistor which supplies the control voltage to the op amplifier, and a second input resistor which supplies the control voltage to the transistor,
wherein the weighting circuit includes voltage division resistors which divide the control voltage,
wherein the offset voltage applying circuit includes an offset voltage source,
wherein the adding circuit includes a second op amplifier, a negative feedback circuit comprising resistors negative feedback-connected to the second op amplifier, and third, fourth and fifth input resistors which respectively supply the non-linear basic control voltage, the division control voltage and the offset voltage to a non-inversion input of the second op amplifier, and
wherein a controlled load circuit is connected to an output of the second op amplifier.

2. The non-linear circuit according to claim 1, wherein in the negative feedback circuit comprising the resistor and transistor negative feedback-connected to the op amplifier, the resistor is connected between an output of the op amplifier and an inversion input thereof, a collector-emitter path of the transistor is connected between the inversion input of the op amplifier and a ground point, and the second input resistor is connected to a base of the transistor.

3. The non-linear circuit according to claim 1, wherein in the positive feedback circuit comprising the resistor positive feedback-connected to the op amplifier, the resistor is connected between the output of the op amplifier and a non-inversion input thereof, and the input resistor is connected to the non-inversion input of the op amplifier.

4. The non-linear circuit according to any of claim 1 through 3, wherein the op amplifier and the second op amplifier are configured in such a manner that gains thereof are controllable.

5. The non-linear circuit according to any of claims 1 through 4, wherein the controlled load circuit is a circuit which includes a variable capacitance diode used as a non-linear element.
